(19) United States
(12) Patent Application Publication
(10) Pub. No.: US 2023/0073413 A1
(43) Pub. Date: Mar. 9, 2023

(54) Coil Replacement Load Leveling System with Safe Height Feature.

(71) Applicant: Wheel Pros, LLC, Greenwood Village, CO (US)

(72) Inventors: Reno Heon, San Luis Obispo, CA (US); Dustin Heon, Arroyo Grande, CA (US)

(73) Assignee: Wheel Pros, LLC, Greenwood Village, CO (US)

(21) Appl. No.: 17/902,980

(22) Filed: Sep. 5, 2022

Related U.S. Application Data
(60) Provisional application No. 63/241,049, filed on Sep. 6, 2021.

(51) Int. Cl. B60G 17/056

(52) U.S. Cl. CPC B60G 17/0565; B60G 2202/152; B60G 2300/02; B60G 2500/2021

(57) ABSTRACT

A primary air suspension system with the reliability of a secondary air suspension system by guaranteeing a minimum pressure in the air spring through a simple mechanical residual pressure valve. The residual pressure valve is set to the air spring pressure required to hold the rear of the unloaded pickup truck at the designed ride height if any of the components (compressor, tank, valves, air lines, Schrader valve, or electronic controller) failure.

### CROSS REFERENCE TO RELATED APPLICATIONS

This utility patent application claims priority back to U.S. Provisional No. 63241049, filed, Sep. 6, 2021, the contents of which are incorporated by reference.

### STATEMENT REGARDING FEDERALLY SPONSORED RESEARCH OR DEVELOPMENT

This invention was not federally sponsored.

### BACKGROUND OF THE INVENTION

Field of the invention: This invention relates to the general field of suspension for vehicles, and more particularly to a primary air suspension system with a secondary air suspension system with a mechanical pressure valve.

This invention is a primary air suspension system which has additional reliability of a secondary air suspension system which provides a minimum pressure in the air spring through a simple mechanical residual pressure valve. The residual pressure valve is set to the air spring pressure required to hold the rear of an unloaded pickup truck at the designed ride height. With this residual check valve placed directly at the air spring fitting, failure of any of the following components will no longer yield an inoperable vehicle: compressor, tank, valves, air lines, Schrader valve, or electronic controller.

Background of the invention: Vehicles generally come with leaf-spring suspension, which consists of one or more bent pieces of metal that rest the vehicle frame on the axle and absorb a lot of the rough ride experienced by the tires. Some vehicles have a combination of leaf-spring (mechanical) suspension and air suspension. The benefit of these types of systems is that even if the air management system fails, the vehicle is still suspended on the leaf spring. Still others have coil springs which absorb the shocks, usually in conjunction with a 5-link connection package.

Conventional pickup truck rear suspension has commonly utilized leaf spring style suspension. Recent generations of RAM pickup trucks have changed the rear suspension design to coil springs with a 5-link system as illustrated in FIG. 1.

The Dodge 2400 Air Spring Rear Suspension package provides an alternative by placing air springs on a traditional pickup RAM rear suspension. This system, however, has a major drawback in that if any of the major components, such as the compressor, tank, valves, or ECU, fail, the air springs fail and no long support the weight of the vehicle. This leaves the vehicle inoperable, as there is no longer any suspension and the vehicle will “rattle apart” quickly if the user continues to drive it.

FIG. 2 illustrates what is referred to as a “primary air suspension system” because the weight of the vehicle is supported only with the air springs. These systems are typically controlled by an electronic air management system (compressor, tank, valves, ECU) which automatically increases or decreases the amount of air in the air springs as required. One known drawback to this type of system is that if any one of these air management system components fail, the air springs will no longer support the weight of the vehicle leaving the vehicle inoperable.

Problem Described: Therefore, there is a need for an air suspension system for a vehicle that does not become nonfunctional if there is a problem with the air management system.

Summary of Invention: The invention provides a solution to this problem by describing a primary air suspension system with the reliability of a secondary air suspension system by guaranteeing a minimum pressure in the air spring through a simple mechanical residual pressure valve. The residual pressure valve is set to the air spring pressure required to hold the rear of the unloaded pickup truck at the designed ride height if any of the components (compressor, tank, valves, air lines, Schrader valve, or electronic controller) failure.

### Advantages Over Products Currently on the Market

While the concept of air spring is not new, the problem of how to maintain some semblance of vehicle functionality if part of the air management system fails remains a problem. This invention guarantees that the air springs will maintain a minimum pressure in spite of failings of one or more key components of the air management system. The first advantage is that this invention can be retrofitted into a variety of vehicles - specifically the rear suspension of pickup trucks. Second, the invention has a safe height feature that guarantees that the vehicle will continue to be operable in the case of failure of any of the following components: compressor, tank, valves, air lines, Schrader valve, or electronic controller. A third advantage is in cost. The invention reduces the average cost of retrofitting air sprints as the cost of an electronic air management system can be avoided by using a simple manual Schrader inflation kit without any concern for being left stranded without a compressed air supply available.

Even in cases where a user wants to vehicle to be lowered (either for style, or ease of passenger/cargo loading and unloading), the user need only remove the residual pressure valve.

In short, the novel invention described herein yields a primary air suspension system with the reliability of a secondary air suspension system by guaranteeing a minimum pressure in the air spring through a simple mechanical residual pressure valve. The residual pressure valve is set to the air spring pressure required to hold the rear of the unloaded pickup truck at the designed ride height. With this residual check valve placed directly at the air spring fitting, failure of any of the following components will no longer yield an inoperable vehicle: compressor, tank, valves, air lines, Schrader valve, or electronic controller.

Prior Art. The prior art provides the current state-of-the-art in installable air springs and other inventions relating to the technologies utilized by the current invention.

EP496426 discloses a residual pressure maintenance valve in a tubular air line (of an air supply system, wherein both the valve seat and the valve body are designed as cooperating end parts of a joint in the tubular air line and the valve seat is arranged on the pressure generator side of the air line and the valve body is arranged on the pressure consumer side of the air line, the end part designed as a valve body has a vent into the valve housing and active surfaces acted on by the housing interior pressure such that, in addition to the pressure generated by the pressure generator, the pressure present in the pressure consumer also acts as opening pressure, wherein a residual pressure is maintained on the pressure consumer side. This invention, however, relates to an air line rather than an air spring.

DE102017102714 describes an air spring or air spring “damper”, having a rolling piston, a cover element, an air spring bellows, the rolling piston and the cover element forming a fluid-filled Pressure chamber connects, and a level control system for regulating the level of the vehicle or the driver’s cab. This invention, however, is substantially more complex and expensive than the current invention and has a fluid-filled pressure chamber rather than an air spring.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a perspective view of a prior art rear suspension system utilizing coil springs.

FIG. 2 is a perspective view of another prior art rear suspension system utilizing air springs and a 5-Link system.

FIG. 3 is a side view of a traditional suspension system using leaf springs and an air spring as a secondary source of suspension.

FIG. 4 is a perspective view of one embodiment of the invention.

### DETAILED DESCRIPTION OF THE FIGURES

The present invention is a uniquely designed extendable piston assembly, utilizing unique and effective/efficient technologies to create an air spring with improved vertical travel in a package small enough to be installed in a wide variety of vehicles. The various advantages provided by this invention are described more fully with respect to the drawings that have been provided.

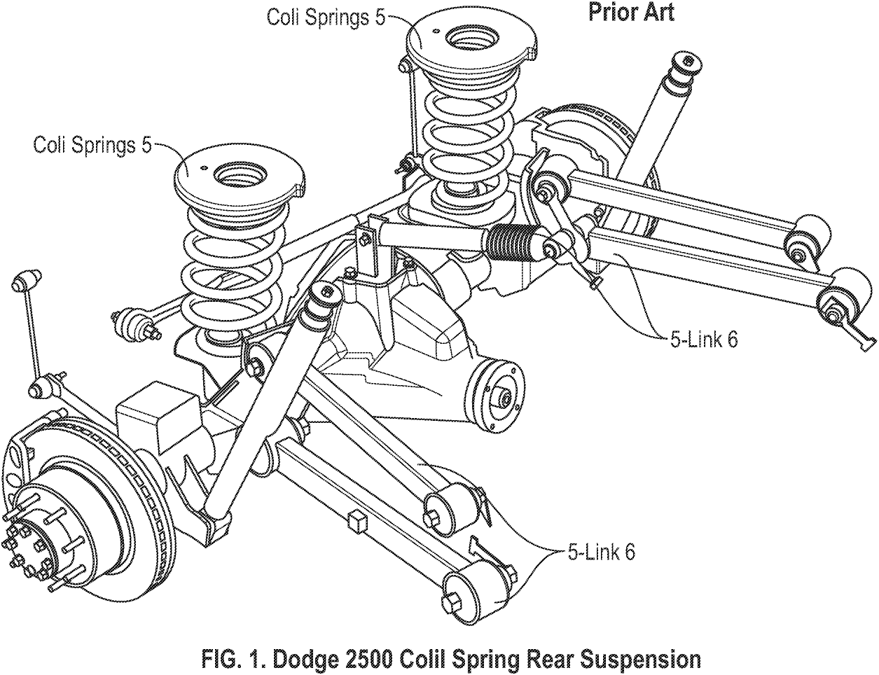

FIG. 1 is a perspective view of a prior art air spring in a traditional pickup truck rear. Conventional pickup truck rear suspension has commonly utilized leaf spring style suspension. Recent generations of RAM pickup trucks have changed the rear suspension design to coil springs 5 with a 5-link system 6 as illustrated in FIG. 1.

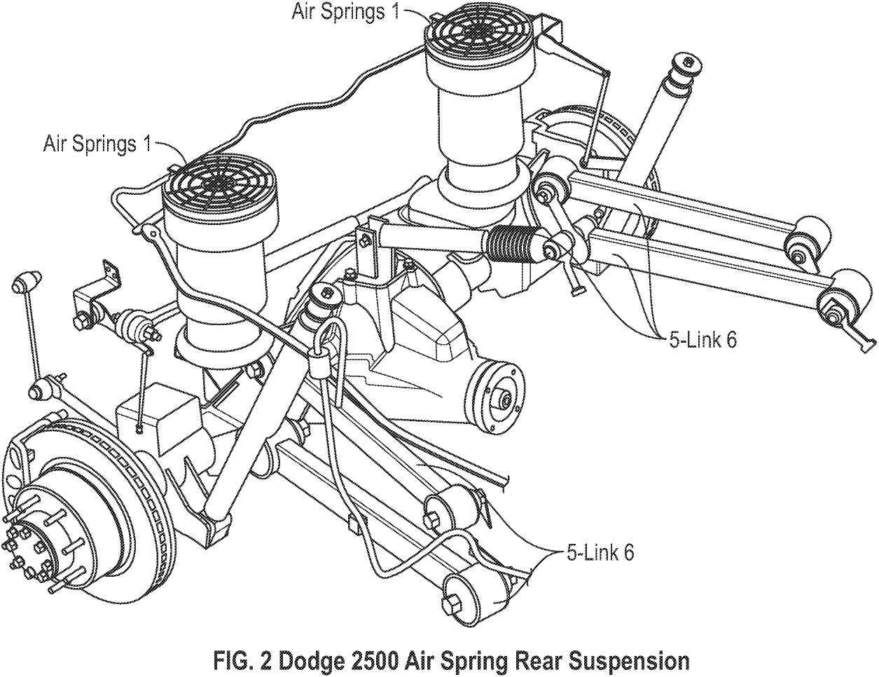

FIG. 2 is a perspective view of another prior art rear suspension system utilizing air springs and a 5-Link system. The coil springs on the RAM rear suspension can easily be replaced with air springs to add load leveling and ride quality benefits as illustrated in FIG. 2.

FIG. 2 illustrates what is referred to as a “primary air suspension system” because the weight of the vehicle is supported only with the air springs. These systems are typically controlled by an electronic air management system (compressor, tank, valves, ECU) which automatically increases or decreases the amount of air in the air springs as required. One known drawback to this type of system is that if any one of these air management system components fail, the air springs will no longer support the weight of the vehicle leaving the vehicle inoperable.

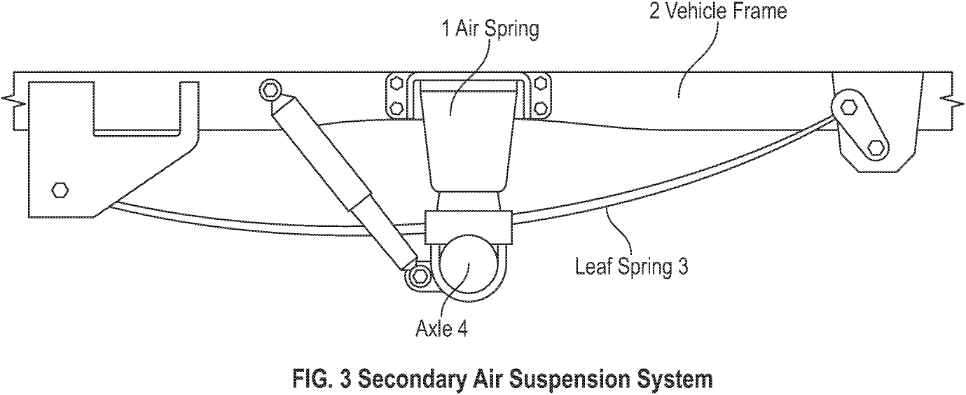

FIG. 3 is a side view of a traditional suspension system using leaf springs and an air spring as a secondary source of suspension FIG. 3 illustrates a “secondary air suspension system” where the air spring is assisting the factory leaf spring to support the weight of the vehicle. The amount of pressure in the air spring can be controlled manually by adding air through a Schrader valve or automatically through an electronic air management system (compressor, tank, valves, air lines, and electronic controller). One benefit to a secondary air suspension system is that if any of the air management components fail, the vehicle is still operable because the factory leaf spring suspension is still present.

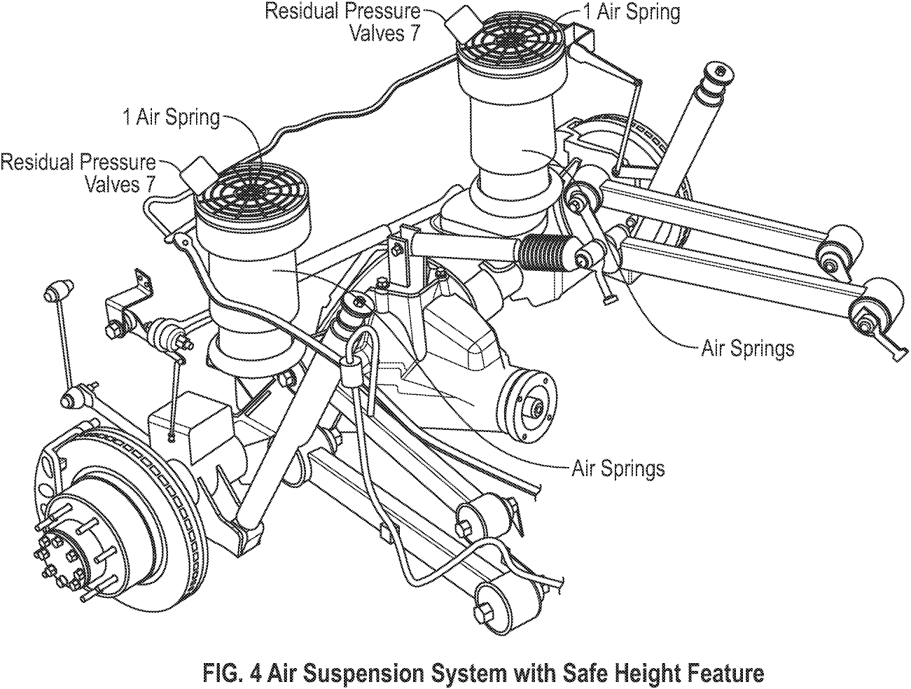

FIG. 4 is a perspective view of one embodiment of the invention. The novel invention described herein yields a primary air suspension system with the reliability of a secondary air suspension system by guaranteeing a minimum pressure in the air spring through a simple mechanical residual pressure valve. The residual pressure valve is set to the air spring pressure required to hold the rear of the unloaded pickup truck at the designed ride height. With this residual check valve placed directly at the air spring fitting, failure of any of the following components will no longer yield an inoperable vehicle: compressor, tank, valves, air lines, Schrader valve, or electronic controller.

To summarize the advantages the current invention provides over the prior art and products currently on the market, by guaranteeing a minimum air pressure for the air springs, this invention is a) easily retrofittable into a wide variety of vehicles, b) provides a safe heigh feature that keeps the vehicle operational even if there is a failure in the compressor, tank, valves, air lines, Schrader valve, or electronic controller, c) provides a cost-effective air spring retrofit package as the user can avoid the expense of buying and installing an electronic air management system by using a simple manual Schrader inflation kit without any concern for being left stranded without a compressed air supply available.

As has been mentioned previously, even if the user later wants to lower the vehicle, he/she can easily do so by simply removing the residual pressure valve.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

Many aspects of the invention can be better understood with references made to the drawings as attached. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

Reference Numbers Used:
1. Air Spring
2. Vehicle Frame
3. Leaf Spring
4. Axle
5. Coil Springs
6. 5-Link
7. Residual Pressure Valves

What I claim is:

1. A Coil Replacement Load Leveling System with Safe Height Feature, consisting of, means to generate a minimum air pressure for the air springs, where the coil replacement load leveling system with safe height feature is retrofittable into a wide variety of vehicles, and additionally provides a safe height feature that keeps the vehicle operational even if there is a failure in the compressor, tank, valves, air lines, Schrader valve, or electronic controller, which additionally provides a cost-effective air spring retrofit package as the user can avoid the expense of buying and installing an electronic air management system by using a simple manual Schrader inflation kit without any concern for being left stranded without a compressed air supply available.

2. A suspension system with a primary air suspension system, a secondary air suspension system, and a safe height feature.

3. The suspension system of claim 2, where the safe height feature comprises a minimum pressure in the air spring, where the minimum pressure in the air spring is created by a residulal pressure valve.

4. The suspension system of claim 2, where the minimum pressure is sufficient to maintain a desinged ride height.

5. The suspension system of claim 2, where the secondary air suspension system comprises a mechanical pressure valve.

6. The suspension system of claim 2, where the secondary air suspension system provides a backup system in the event that the primary air suspension system fails.

7. The suspension system of claim 2, where the residual pressure valve has an air spring pressure, where the air spring pressure is an air pressure required to hold a rear of an unloaded pickup truck at the designed ride height.

8. The suspension system of claim 2, where the residual check valve is placed directly at an air spring fitting.

9. The suspension system of claim 2, where failure of any of the following components will no longer yield an inoperable vehicle: compressor, tank, valves, air lines, Schrader valve, or electronic controller.

10. The suspension system of claim 2, where the residual pressure valve creates a minimum pressure in the air spring.

11. The suspension system of claim 10, where the minimum pressure is sufficient to maintain the desinged ride height.

12. The suspension system of claim 10, where an entire weight of a vehicle can be supported by four air springs.

13. The suspension system of claim 10, where the vehcle additional comprises four leaf springs, with each of the four air springs attached to one of the four leaf springs.

14. A suspension system with a primary air suspension system, a secondary air suspension system, and a safe height feature, where the safe height feature comprises a minimum pressure in the air spring, where the minimum pressure in the air spring is created by the residual pressure valve.

15. The suspension system of claim 14, where the minimum pressure is sufficient to maintain a desinged ride height.

16. The suspensin system of claim 15, where the secondary air suspension system comprises a mechanical pressure valve.

17. The suspension system of claim 16, where the secondary air suspension system provides a backup system in the event that the primary air suspension system fails.

18. The suspension system of claim 17, where the residual pressure valve has an air spring pressure, where the air spring pressure is an air pressure required to hold a rear of an unloaded pickup truck at the designed ride height, where the residual check valve is placed directly at an air spring fitting.

19. The suspension system of claim 18, where failure of any of the following components will no longer yield an inoperable vehicle: compressor, tank, valves, air lines, Schrader valve, or electronic controller, where the residulal pressure valve creates a minimum pressure in the air spring.

20. The suspension system of claim 19, where the minimum pressure is sufficient to maintain the desinged ride height, where an entire weight of a vehicle can be supported by four air springs, where the vehcle additionally comprises four leaf springs, with each of the four air springs attached to one of the four leaf springs.
